(19) United States
(12) Patent Application Publication
(10) Pub. No.: US 2026/0245147 A1
(43) Pub. Date: Aug. 20, 2026

(54) METHOD AND APPARATUS FOR SUPPORTING DISPLAY OF COMMUNICATED DATA ELEMENTS ON SMALL DISPLAYS

(71) Applicant: Dunamu Inc., Seoul (KR)

(72) Inventors: Jihoon Lim, Seoul (KR); Kunsup Song, Seoul (KR); Grace Yang, Seoul (KR)

(21) Appl. No.: 19/348,440

(22) Filed: Oct. 2, 2025

(30) Foreign Application Priority Data
Feb. 19, 2025 (KR) 10-2025-0021462

(51) Int. Cl. G06Q 40/04

(52) U.S. Cl. CPC G06Q 40/043

(57) ABSTRACT

Aspects described herein relate to display of data elements of high-volume, high-speed data on limited display screens. The method comprises acquiring information associated with a plurality of option products for a specific underlying asset, the information including, for each option product, information on an expiration date and information on a strike price for the specific underlying asset on the expiration date, generating a first chart in which the information associated with the plurality of option products is mapped, and outputting the generated first chart as at least part of a user interface, wherein a first axis of the first chart represents time information on the expiration dates of the plurality of option products, and a second axis of the first chart represents information on the strike prices of the specific underlying asset associated with the plurality of option products.

### CROSS-REFERENCE TO RELATED APPLICATION

The present application claims priority to and the benefit of Korean Application No. 10-2025-0021462, filed on February 19, 2025, in the Korean Intellectual Property Office, the entire disclosure of which is incorporated by reference herein.

### BACKGROUND

### FIELD

The present disclosure relates to a method and an apparatus for data processing and display of complex data structures on user interfaces.

### DESCRIPTION OF THE RELATED ART

An increasing amount of complex work is done using computing devices (e.g., mobile phones) with relatively limited display screens. For example, users might perform complex data analysis tasks and/or make major life decisions using a relatively small screen that can only display a limited amount of information at once. This can be particularly cumbersome in the context of processes that require analysis of real-time, complex data, as it can be practically quite difficult for users to analyze that data (particularly given how quickly it moves/changes) on a limited display screen.

An option product is a financial instrument that trades the right to buy or sell a specified underlying asset (e.g., stock, bond, currency, commodity, or cryptocurrency) at a predetermined price (strike price) either within a specified period or on an expiration date. Trading in option products constitutes an important form of derivative trading in financial markets, offering investors opportunities to generate profit by predicting price rises or falls in the asset and, at the same time, serving widely as a hedge against market volatility. Consequently, option product trading affords investors flexibility to obtain profit or avoid risk without directly participating in spot transactions linked to movements of the underlying asset price.

Because option product trading inherently requires real time market information and complex analysis, demand is growing for systems that can efficiently and promptly furnish users with diverse information—such as expiration dates, strike prices, quotations, and trading volume. In turn, conventional systems have limitations in real time data processing and information delivery efficiency, making it difficult to provide users with an optimal trading environment.

### SUMMARY

Some aspects disclosed in the present specification provide a technique that enables a user to readily grasp information associated with a plurality of option products by presenting that information in the form of a chart plotted against expiration dates and strike prices.

Some aspects provide a technique that lets the user easily comprehend information related to a plurality of option products by associating those option products, which represent future price information, with a price fluctuation graph showing past and present price information.

Some aspects provide a technique for effectively supplying information associated with expected profit of an option product selected by the user from among a plurality of option products.

The present disclosure furnishes a method, a computer-readable recording medium storing a computer program, and an apparatus (system) for supporting trading of option products.

The technical problems addressed here are not limited to those mentioned above; additional unstated technical problems will be apparent to persons of ordinary skill in the art from the following description.

The disclosure can be implemented in various forms, including a method, a system (device), or a computer program stored on a readable storage medium.

Aspects described herein may provide for a method for supporting display of data, the method being executed by at least one processor, may include acquiring information associated with a plurality of option products for a specific underlying asset, the information including, for each option product, information on an expiration date and information on a strike price for the specific underlying asset on the expiration date, generating a first chart in which the information associated with the plurality of option products is mapped, and outputting the generated first chart as at least part of a user interface, wherein a first axis of the first chart represents time information on the expiration dates of the plurality of option products, and a second axis of the first chart represents information on the strike prices of the specific underlying asset associated with the plurality of option products.

The generating the first chart may include mapping, to a first column of the first chart, a first group of option products whose expiration dates may be a first expiration date among the plurality of option products.

The generating the first chart may include mapping, to a first row of the first chart, a second group of option products whose strike prices may be a first strike price among the plurality of option products.

The generating the first chart may include generating a plurality of option blocks corresponding respectively to the plurality of option products, and mapping the plurality of option blocks to the first chart, wherein each of the plurality of option blocks is mapped to a position corresponding, on the first axis, to information on the expiration dates of the respective option products and, on the second axis, to information on the strike prices of the respective option product

The outputting may include receiving a predetermined manner input with respect to at least one of a direction of the first axis of the first chart or a direction of the second axis of the first chart, and in response to receiving the predetermined manner input, changing positions or types of option blocks mapped on the first chart.

The changing may include in response to receiving the predetermined manner input with respect to the first axis direction of the first chart, adjusting a range or interval of the expiration dates displayed on the first axis, and changing the positions or types of the option blocks so that option blocks whose expiration dates fall within the adjusted range or interval may be mapped on the first chart.

The changing may include in response to receiving the predetermined manner input with respect to the second axis direction of the first chart, adjusting a range or interval of the strike prices displayed on the second axis, and changing the positions or types of the option blocks so that option blocks whose strike prices fall within the adjusted range or interval may be mapped on the first chart.

The information associated with the plurality of option products may further include trading volume information for each of the plurality of option products, and generating the plurality of option blocks includes generating option blocks in which the trading volume information for each of the plurality of option products is displayed.

The trading volume information for each of the plurality of option products may be visually displayed on the plurality of option blocks to be classified according to predetermined numeric ranges.

The information associated with the plurality of option products may further include quotation information for each option product, and generating the plurality of option blocks may include generating option blocks in which the quotation information for each option product is displayed.

The outputting may comprise outputting, at a position adjacent to the first chart, a second chart that represents price fluctuation information of the specific underlying asset as at least part of the user interface, a third axis of the second chart represents time information and a fourth axis represents price information of the specific underlying asset.

The first axis of the first chart and the third axis of the second chart may be aligned on a same line so as to represent a continuous flow of time.

In some examples, the method further includes, in response to receiving an input selecting a first option product among the plurality of option products, outputting information associated with expected profit of the first option product as at least part of the user interface.

The expected profit may be calculated based on a strike price of the first option product and an expected price of the specific underlying asset on an expiration date of the first option product, and outputting the information associated with the expected profit may include outputting, as part of the user interface, a third chart that contains information regarding a relationship between the strike price and the expected price.

The outputting the information associated with the expected profit further may include, in response to receiving an input that adjusts the expected price through the third chart, recalculating the expected profit, and outputting information on the recalculated expected profit as at least part of the user interface.

The third chart may include information on a profit zone of the first option product.

The outputting the information associated with the expected profit further may comprise receiving an input selecting a second option product whose expiration date is identical to an expiration date of the first option product, and the information associated with the expected profit may include information on expected profits for the first option product and the second option product.

The receiving the input selecting the second option product comprises may comprise receiving the input selecting the second option product from among at least some option products whose expiration date is identical to an expiration date of the first option product for which selection is active.

The method may further include, in response to receiving an input requesting an order for the selected first option product, outputting order related information for the first option product as at least part of the user interface, the order related information including quantity information for the first option product and information on a total expected profit of the first option product.

The outputting the order related information further may include, in response to receiving an input setting the quantity information of the first option product, calculating the total expected profit based on the set quantity information, and outputting information on the calculated total expected profit as at least part of the user interface.

A computer-readable recording medium may store a computer program for executing the above-mentioned methods on a computer.

A computing device for supporting analysis of data may include a memory, and at least one processor coupled to the memory and configured to execute at least one computer-readable program stored in the memory, wherein the at least one program may instruct the processor to acquire information associated with a plurality of option products for a specific underlying asset—the information including, for each option product, expiration date information and strike price information for the specific underlying asset on the respective expiration date, generate a first chart in which the information associated with the plurality of option products is mapped, and output the generated first chart as at least part of a user interface, wherein a first axis of the first chart represents time information related to the expiration dates of the plurality of option products, and a second axis of the first chart represents strike price information of the specific underlying asset associated with the plurality of option products.

Because a plurality of option products may be provided in the form of a chart plotted against a plurality of expiration dates and a plurality of strike prices, the user may view, at a glance, the option products corresponding to those expiration dates and strike prices. The user can thus ascertain an expiration date or a strike price for each option product without switching or leaving the screen and can change ranges or intervals of expiration dates or strike prices simply by manipulating the chart.

By connecting, in a manner that represents a continuous flow of time, a first chart showing information related to a plurality of option products and a second chart showing past and present price fluctuation information of the specific underlying asset, the user may be enabled to easily understand the relationship between the price of the specific underlying asset and the strike prices of the option products. The user can also alternate between the first and second charts without leaving the screen, facilitating comparison between price fluctuation information of the specific underlying asset and information related to the plurality of option products.

On the chart that represents information for a plurality of option products, trading volume information for each option product may be displayed differentially through color, brightness, saturation, or shape of the option blocks, which may enable the user to intuitively compare trading volumes.

By receiving a user input adjusting an expected price of the specific underlying asset at the expiration date and by calculating and providing the corresponding expected profit, the processor may assist the user in formulating an option purchase strategy.

By combining at least some of a plurality of call option products and/or a plurality of put option products related to a specific underlying asset, the user can create a synthetic position of the user’s own and, through information on expected profit of the created synthetic position, establish a rational purchase strategy for option products.

A chart representing price fluctuation information of the specific underlying asset and a chart representing price fluctuation information of option products may be output at adjacent positions and synchronized on the same time axis, allowing the user to easily identify price fluctuation trends of the specific underlying asset and the option products over the same time period.

Before creating an order to purchase an option product, the user can readily obtain various information—such as information on open interest or market depth—related to the option product and the specific underlying asset associated with the option product.

In some examples, before registering a buy and sell order for an option product, the user can confirm quantity and/or price information for the option product and receive total expected profit information based on that confirmation, thereby assisting final decision making on trading the option product.

The processor may adopt an optimal presentation form for providing information related to option products depending on characteristics of the option products (e.g., long-term or short-term option products), thereby enabling the user to more effectively comprehend option product information.

The effects of the present disclosure may be not limited to those mentioned above; other effects not so mentioned will be clearly understood by persons of ordinary skill in the art from the scope of the claims.

### BRIEF DESCRIPTION OF THE DRAWINGS

Examples of the present disclosure will be described below with reference to the accompanying drawings, wherein like reference numerals represent like elements, without limitation thereto.

FIG. 1 illustrates an example of a user interface for supporting display of data elements.

FIG. 2 is a schematic diagram illustrating an example in which an information processing system is connected so as to communicate with a plurality of user terminals to provide a service that supports display of data elements.

FIG. 3 is a block diagram illustrating an example of internal configurations of a user terminal and an information processing system.

FIG. 4 illustrates an example in which a first chart containing information associated with a plurality of data elements is output.

FIG. 5 illustrates an example in which a second chart containing value fluctuation information of a specific category is output.

FIG. 6 illustrates an example in which information associated with expected value of a data element is output.

FIG. 7 illustrates an example in which information associated with expected value of a plurality of data elements is output.

FIG. 8 illustrates an example in which detailed information of a selected data element among a plurality of data elements is output.

FIG. 9 illustrates an example in which various information associated with a plurality of data elements is output.

FIG. 10 illustrates an example in which information associated with an interaction with a data element is output.

FIG. 11 illustrates an example in which information associated with long-term data elements is output.

FIG. 12 illustrates an example of setting a registration alert for a data element.

FIG. 13 is a flowchart illustrating a method for supporting display and actions related todata elements.

### DETAILED DESCRIPTION

Hereinafter, specific details for implementing examples of the present disclosure will be described in detail with reference to the accompanying drawings. However, in the following description, detailed descriptions of well-known functions or configurations will be omitted when it is determined that such descriptions may unnecessarily obscure the gist of the present disclosure.

In the attached drawings, the same or corresponding components may be assigned the same reference numerals. In the following description of examples, descriptions of the same or corresponding components may be omitted to avoid redundancy. Nevertheless, omission of a description of a component does not mean that such component is not included in an example.

Advantages, features, and methods for achieving them according to the disclosed examples will become apparent from the examples described below with reference to the accompanying drawings. However, the present disclosure is not limited to the examples disclosed below and may be implemented in various different forms. The examples may be provided merely to make the present disclosure complete and to fully inform those skilled in the art of the scope of the invention.

Terms used in the present specification will be briefly explained and the disclosed embodiments will be described in detail. While general terms that are currently widely used have been selected in consideration of functions in the present disclosure, the terms may vary depending on the intention of a person skilled in the art, precedent, or the advent of new technology. In certain cases, terms arbitrarily selected by the applicant are also used, in which case the meaning thereof will be described in detail in the relevant portion of the description of the invention. Therefore, the terms used in the present disclosure should be defined based on the meaning of the term and the overall content of the present disclosure rather than the mere name of the term.

Singular expressions in the present specification include plural expressions unless clearly specified otherwise by context. Likewise, plural expressions include singular expressions unless clearly specified otherwise by context. Throughout the specification, when a part is described as including an element, the part may further include other elements unless specifically stated otherwise.

Further, the terms “module” or “unit” used in the specification refer to software or hardware components that perform specified roles. The “module” or “unit” is not limited to software or hardware. A “module” or “unit” may be configured so as to reside on an addressable storage medium or to be executable by one or more processors. Accordingly, a “module” or “unit” may include at least one of software components, object-oriented software components, class components, task components, processes, functions, attributes, procedures, subroutines, program-code segments, drivers, firmware, microcode, circuits, data, databases, data structures, tables, arrays, or variables. The functions provided by components and “modules” or “units” may be combined into a smaller number of components and “modules” or “units” or further separated into additional components and “modules” or “units.”

According to an example of the present disclosure, a “module” or “unit” may be implemented by a processor and a memory. The “processor” should be broadly construed to include a general-purpose processor, a central processing unit (CPU), a microprocessor, a digital signal processor (DSP), a controller, a microcontroller, or a state machine. In some environments, the “processor” may denote an application-specific integrated circuit (ASIC), a programmable logic device (PLD), or a field-programmable gate array (FPGA). The “processor” may also denote a combination of processing devices such as a combination of a DSP and a microprocessor, a combination of a plurality of microprocessors, a combination of one or more microprocessors combined with a DSP core, or any other such configuration. The “memory” should be broadly construed to include any electronic component capable of storing electronic information. The “memory” may denote various types of processor-readable media such as random-access memory (RAM), read-only memory (ROM), non-volatile RAM (NVRAM), programmable ROM (PROM), erasable PROM (EPROM), electrically erasable PROM (EEPROM), flash memory, magnetic or optical data storage devices, or registers. If a processor may read information from or write information to a memory, the memory is said to be in electronic communication with the processor. A memory integrated in a processor is in electronic communication with the processor.

In the present disclosure, a “system” may include at least one device among a server device and a cloud device but is not limited thereto. For example, the system may be configured of one or more server devices. As another example, the system may be configured of one or more cloud devices. As yet another example, the system may be configured so that server devices and cloud devices operate together.

In the following examples, terms such as first, second, A, B, (a), or (b) may be used only to distinguish one component from another component, and the terms do not limit the nature, order, or sequence of the components.

In the following examples, when a component is described as being “connected,” “coupled,” or “linked” to another component, the component may be directly connected or coupled to that other component or there may be another component “connected,” “coupled,” or “linked” between the components.

Further, the terms “include” or “comprise” used in the following examples do not exclude the presence or addition of one or more other components, steps, operations, or elements apart from the stated components, steps, operations, or elements.

In the present disclosure, “each of a plurality of A” may refer to each of all components included in the plurality of A or to each of some of the components included in the plurality of A.

In the present disclosure, unless stated otherwise, “or” should be understood as allowing all combinations of a plurality of elements connected by “or.” For example, “A or B” may include “A,” “B,” and “A and B,” and “A, B, or C” may include “A,” “B,” “C,” “A and B,” “B and C,” “A and C,” and “A, B, and C.”

Before describing various examples of the present disclosure, terms used will be described.

“Information associated with X” and “X information” may be used interchangeably with the same meaning.

In the present disclosure, a “user” may denote a user who uses a service provided on the basis of various examples of the present disclosure, such as a service supporting display of data elements.

In the present disclosure, an “option product” may denote a financial product that trades a right to purchase or to sell a particular underlying asset in a financial market under predetermined conditions. The option product may include a “call option product” that grants a right to purchase the underlying asset at a predetermined strike price within a specified period or on a specified expiration date and a “put option product” that grants a right to sell the underlying asset at a predetermined strike price within a specified period or on a specified expiration date.

In the present disclosure, a “user interface” is not limited to a single screen displayed on a display of a user terminal, etc., and may denote one or more screens including windows, icons, buttons, or menus so that a user may receive information or interact. The specific configuration of the user interface illustrated in each drawing is merely exemplary for description and is not limited thereto. For example, arbitrary graphic objects or graphic elements different from those illustrated may be used.

Various examples of the present disclosure will now be described in detail with reference to the attached drawings. Hereinafter, various examples of a user interface for supporting option product trading will be described as examples of a method for supporting the display of communicated data elements on small displays.

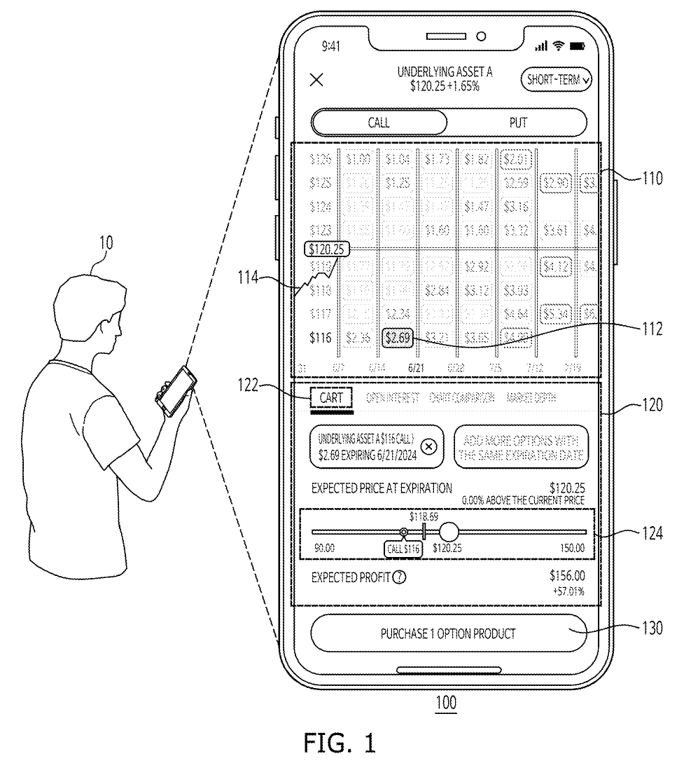

FIG. 1 is a diagram illustrating an example of a user interface (100) for supporting the display of data elements. Specifically, FIG. 1 is a diagram illustrating an example of a user interface (100) for supporting trading of option products. The processor (for example, at least one processor of the user terminal or at least one processor of the information processing system) may output, as at least part of the user interface 100, information associated with a plurality of option products for a specific underlying asset. The information associated with the plurality of option products may include expiration date information for each of the plurality of option products or strike price information for the specific underlying asset on the expiration date of each of the plurality of option products. Additionally, the information associated with the plurality of option products may further include at least one of trading volume information or quotation information for each of the plurality of option products.

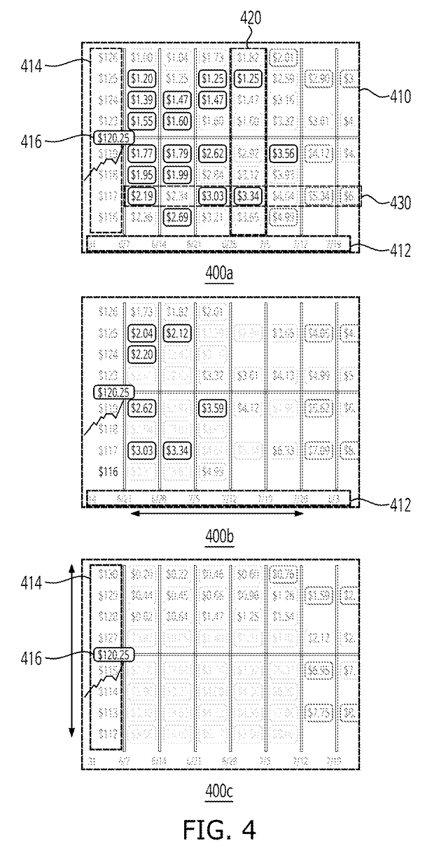

Through the user interface 100 the user 10 may view a plurality of option products for the specific underlying asset. Information on the plurality of option products may be provided in the form of a chart plotted against a plurality of expiration dates and a plurality of strike prices. For example, a first region 110 of the user interface 100 may output a first chart that has, as axes, strike prices of the option products and expiration dates of the option products, and that includes a plurality of option blocks corresponding to the plurality of option products (for example, a first option product 112). As shown in FIG. 1, the plurality of option blocks may be displayed in an array based on the expiration dates and strike prices of the option products. For instance, option blocks having the same expiration date may form a column of the array, and option blocks having the same strike price may form a row of the array. However, this is merely an example, and the configuration of the array may differ. An example in which information on the plurality of option products is output in the form of a chart is described in detail with reference to FIG. 4.

Through the first region 110 of the user interface 100, the user 10 may view a second chart 114 that includes price fluctuation information for the specific underlying asset. For example, the processor may receive a predetermined manner user input for switching the screen (for example, a scroll input, an axis touch input, or a predetermined shortcut key input) and may switch the screen displayed in the first region 110 from the first chart to the second chart 114.

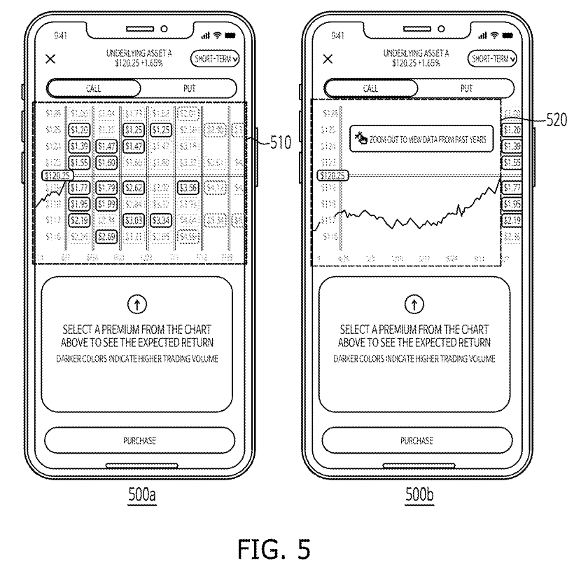

Referring to FIG. 1, a part of the second chart 114 is output in the first region 110, and, when the predetermined manner of input from the user 10 is received, the entire configuration of the second chart 114 may be output in the first region 110. That is, because part of the configuration of the second chart 114 is partially output together with the first chart in the first region 110, the user input for switching the screen to the second chart 114 may be induced. In that case, part of the first chart and part of the second chart 114 may overlap. However, the manner in which the second chart 114 is output in the first region 110 is not limited thereto: the complete configuration of the first chart and the complete configuration of the second chart 114 may be output adjacent to each other on a single screen in the first region 110. Alternatively, only the first chart may be output in the first region 110, and, when the predetermined manner user input is received, the entire configuration of the second chart 114 may be output by switching the screen. An example in which the second chart 114 is output is described in detail with reference to FIG. 5.

Through the first chart the user 10 may select at least one option product among the plurality of option products that the user wishes to purchase. In response to receiving the user input selecting the at least one option product, the processor may output, as at least part of the user interface 100, information associated with expected profit of the selected at least one option product. For example, the processor may output, through a cart tab 122 in a second region 120 of the user interface 100, information associated with expected profit of the first option product 112.

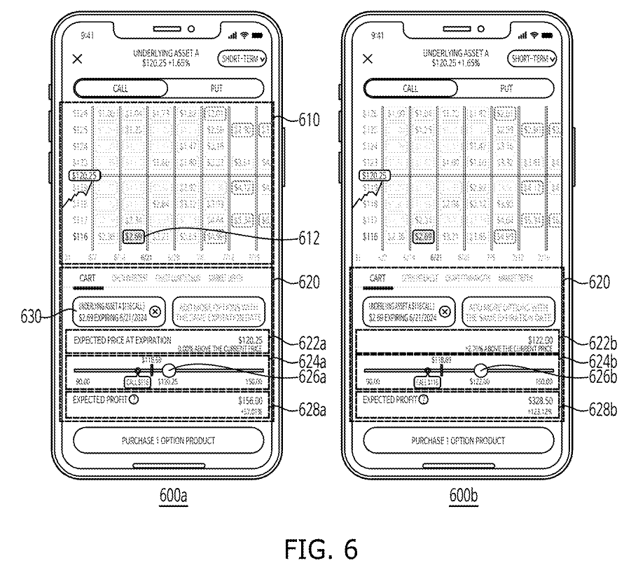

In one example, expected profit of the first option product 112 may be calculated based on the strike price of the first option product 112 and an expected price of the specific underlying asset on the expiration date of the first option product 112. In the second region 120 of the user interface 100 a third chart 124 that includes information regarding the relationship between the strike price and the expected price of the first option product 112 may be output. Through the third chart 124 the user 10 may adjust the expected price of the specific underlying asset on the expiration date of the first option product 112 and may view the expected profit of the first option product 112 corresponding thereto. An example in which information associated with expected profit is output is described in detail with reference to FIG. 6.

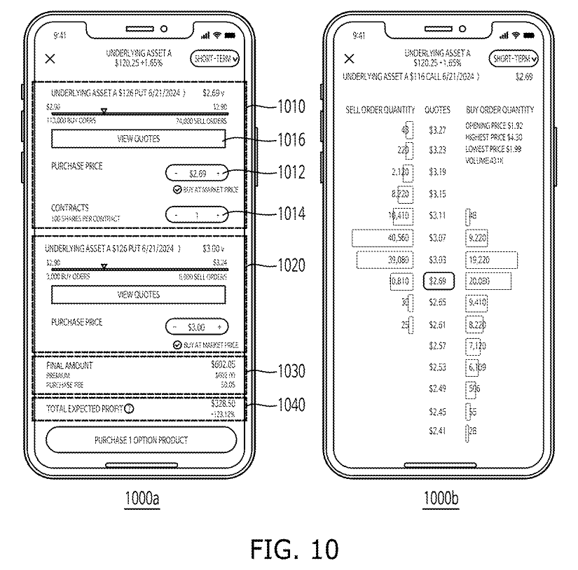

After confirming expected profit of the selected first option product 112, the user 10 may purchase the first option product 112. For example, the user may select, by a touch input or the like, a buy button 130 displayed in the user interface 100. In response to receiving the user input selecting the buy button 130, the processor may output, as at least part of the user interface, information associated with an order for the selected first option product 112. An example in which information associated with an order for an option product is provided is described in detail with reference to FIG. 10.

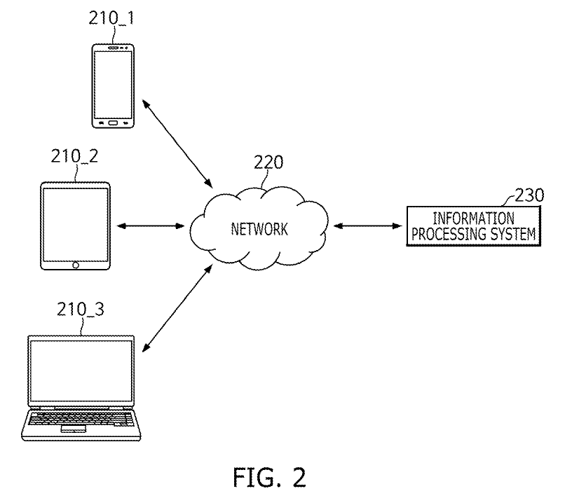

FIG. 2 is a schematic diagram illustrating an example in which an information processing system 230 is connected so as to be able to communicate with a plurality of user terminals 212, 214, and 216 to provide a service that supports display of data elements (e.g., trading of option products). The information processing system 230 may include system(s) capable of providing the service that supports display of data elements (e.g., trade of option products).

In one example, the information processing system 230 may include one or more server devices, or one or more distributed computing devices based on a cloud computing service, that may be able to store, provide, and execute computer executable programs (such as downloadable applications) and data related to the service that supports display of data elements (e.g., trading of option products). Additionally, the information processing system may include a database (not illustrated) related to the service that supports display of data elements (e.g., trading of option products), or may be configured to be able to communicate with such a database.

A service that supports display of data elements (e.g., trading of option products), provided by the information processing system 230, may be provided to users through applications installed on each of the plurality of user terminals 212, 214, and 216. In this case the service may denote a service that provides information associated with a plurality of option products for a specific underlying asset or information associated with expected profit of a selected option product among a plurality of option products.

The plurality of user terminals 212, 214, and 216 may communicate with the information processing system 230 via a network 220. The network 220 may be configured to enable communication between the plurality of user terminals 212, 214, and 216 and the information processing system 230. Depending on installation environment, the network 220 may be configured as a wired network such as Ethernet, power line communication, telephone line communication, or RS serial communication; a wireless network such as a mobile communication network, WLAN, Wi-Fi, Bluetooth, or ZigBee; or a combination thereof. Communication modes may be not limited, and the network 220 may include, in addition to communication that utilizes communication networks (mobile communication network, wired Internet, wireless Internet, broadcast network, or satellite network) making up the network 220, short-range wireless communication between user terminals 212, 214, and 216.

The plurality of user terminals 212, 214, and 216 may transmit a request to the information processing system 230 via the network 220, and, after receiving the request, the information processing system 230 may transmit a response corresponding to the request to the plurality of user terminals 212, 214, and 216.

For example, when information identifying a specific underlying asset for which the user wishes to receive information on option products is transmitted from a user terminal 212, 214, or 216 to the information processing system 230 through user input, the information processing system 230 may transmit, to the user terminal, information associated with a plurality of option products for the specific underlying asset. Also, when information identifying a selected option product among the plurality of option products is transmitted from a user terminal 212, 214, or 216 through user input, the information processing system 230 may transmit, to the user terminal, information associated with expected profit of the selected option product. The user terminal 212, 214, or 216 may output, through the user interface, information associated with a plurality of option products for the specific underlying asset or information associated with expected profit of the selected option product.

In another example, the user terminals 212, 214, and 216 may obtain, via the network 220, from the information processing system 230, information associated with a plurality of option products (for example, expiration date information, strike price information, trading volume information for each option product) and may generate a chart in which the obtained information associated with the plurality of option products is mapped. The user terminals 212, 214, and 216 may also generate, based on the obtained information associated with the plurality of option products, information associated with expected profit of each of the plurality of option products. Additionally, the user terminals 212, 214, and 216 may output the generated chart and/or the generated expected profit information as at least part of the user interface.

In yet another example, in accordance with a user request input to a user terminal 212, 214, or 216, the information processing system 230 may receive, from the user terminal, information identifying a specific underlying asset for which the user wishes to receive information on option products. The information processing system 230 may generate a chart in which information associated with a plurality of option products corresponding to the received information identifying the specific underlying asset is mapped and may transmit the generated chart to the user terminal 212, 214, or 216. Additionally and/or alternatively, the information processing system 230 may generate information associated with expected profit of each of the plurality of option products corresponding to the received information identifying the specific underlying asset and may transmit the generated information to the user terminal 212, 214, or 216. The user terminals 212, 214, and 216 may output, as at least part of the user interface, the received chart and/or the received information associated with expected profit.

However, the example in which the user terminals 212, 214, and 216 output a chart in which information on option products is mapped and/or information associated with expected profit of an option product through communication with the information processing system 230 is not limited thereto. For example, the user terminals 212, 214, and 216 may transmit at least part of the information on option products to the information processing system 230, and the information processing system 230 may generate a chart in which the information on option products is mapped and/or information associated with expected profit of the option product by using the received at least part of the information on option products and information previously stored in the information processing system 230. Alternatively, the user terminals 212, 214, and 216 may receive at least part of the information on option products from the information processing system 230 and may generate a chart in which information on option products is mapped and/or information associated with expected profit of the option product by using the received at least part of the information on option products, information directly received in the user terminals 212, 214, and 216 through user input, and information previously stored in the user terminals 212, 214, and 216. Additionally, the user terminals 212, 214, and 216 may generate a chart in which information associated with option products is mapped without receiving information through the information processing system 230 by using information directly received in the user terminals 212, 214, and 216 through user input and information previously stored in the user terminals 212, 214, and 216. Thereafter, the user terminals 212, 214, and 216 may output the generated chart and/or information associated with expected profit of the option product as at least part of the user interface.

Although FIG. 2 illustrates a mobile phone terminal 212, a tablet terminal 214, and a PC terminal 216 as examples of user terminals, the invention is not limited thereto, and a user terminal 212, 214, or 216 may be any computing device capable of wired or wireless communication and capable of executing an application. For example, the user terminal may include a smartphone, cellphone, navigation device, computer, notebook, digital broadcast receiver, PDA, PMP, tablet PC, game console, wearable device, IoT device, VR device, or AR device. Additionally, although FIG. 2 illustrates three user terminals 212, 214, and 216 communicating with the information processing system 230 via the network 220, the invention is not limited thereto, and a different number of user terminals may be configured to communicate with the information processing system 230 via the network 220.

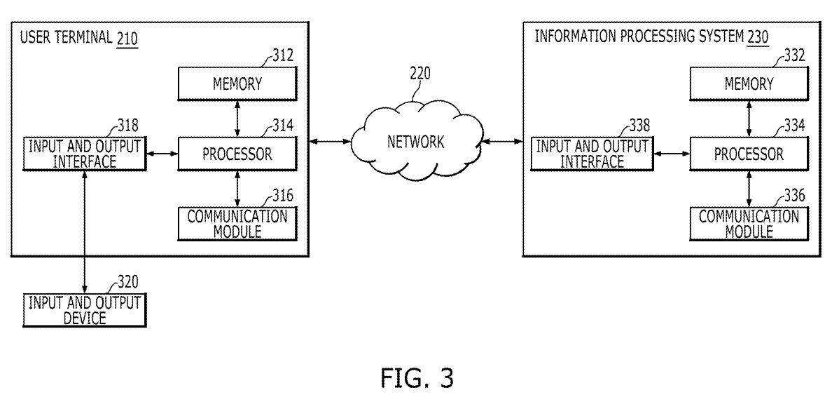

FIG. 3 is a block diagram illustrating exemplary internal configurations of a user terminal 210 and the information processing system 230. The user terminal 210 may denote any computing device capable of executing an application that outputs information associated with a plurality of option products for a specific underlying asset or information associated with expected profit of a selected option product among a plurality of option products and capable of wired or wireless communication and may include, for example, the mobile phone terminal 212, tablet terminal 214, or PC terminal 216 of FIG. 2. As illustrated, the user terminal 210 may include a memory 312, a processor 314, a communication interface 316, and an input/output interface 318. Similarly, the information processing system 230 may include a memory 332, a processor 334, a communication interface 336, and an input/output interface 338. Additionally, an input/output device 320 may be configured, via the input/output interface 318, to input information or data to the user terminal 210 or to output information or data generated by the user terminal 210.

As illustrated in FIG. 3, the user terminal 210 and the information processing system 230 may be configured to communicate information or data via their respective communication interfaces 316 and 336 and the network 220.

The memories 312 and 332 may include non-transitory computer-readable recording media. According to one example, the memories 312 and 332 may include permanent mass storage devices such as a read-only memory (ROM), a disk drive, a solid-state drive (SSD), or flash memory. As another example, a permanent mass-storage device such as a ROM, an SSD, flash memory, or a disk drive may be included in the user terminal 210 or the information processing system 230 as a separate permanent storage device distinct from the memory. Additionally, the memories 312 and 332 may store an operating system and at least one program code—for example, code for an application that acquires and outputs information associated with a plurality of option products for a specific underlying asset or information associated with expected profit of a selected option product among the plurality of option products.

These software components can be loaded into the memories 312 and 332 from computer-readable recording media that may be separate from the memories 312 and 332. Such separate computer-readable recording media may include media that can be directly connected to the user terminal 210 or the information processing system 230—for example, computer-readable recording media such as a floppy drive, disk, tape, DVD/CD-ROM drive, USB memory, or memory card. In another example, the software components may be loaded into the memories 312 and 332 through the communication interfaces 316 and 336 rather than from computer-readable recording media. For instance, at least one program may be loaded into the memories 312 and 332 on the basis of a computer program—such as an application that acquires and outputs information associated with a plurality of option products for a specific underlying asset or information associated with expected profit of a selected option product among the plurality of option products—that is installed by files supplied over the network 220 by a file distribution system that distributes installation files for developers or applications.

The processors 314 and 334 may be configured to process instructions of computer programs by performing basic arithmetic, logic, and input/output operations. The instructions may be supplied to the processors 314 and 334 by the memories 312 and 332 or the communication interfaces 316 and 336. For example, the processors 314 and 334 may be configured to execute instructions received from program code stored in the memories 312 and 332.

The communication interfaces 316 and 336 may provide configurations or functions for enabling the user terminal 210 and the information-processing system 230 to communicate with each other via the network 220 and may provide configurations or functions for enabling the user terminal 210 or the information-processing system 230 to communicate with another user terminal or another system (such as a separate cloud system). Requests or data generated according to program code stored in a recording device such as the memory 312 may be transmitted from the user terminal 210 to the information-processing system 230 via the communication interface 316 under control of the processor 314. Conversely, control signals or instructions provided under control of the processor 334 of the information-processing system 230 may be transmitted to the user terminal 210 via the communication interface 336 and the network 220 and received by the user terminal 210 through its communication interface 316.

The input/output interface 318 may serve as means for interfacing with the input/output device 320. For example, an input device may include a camera with an audio sensor or image sensor, a keyboard, a microphone, or a mouse, and an output device may include a display, a speaker, or a haptic feedback device. In another example, the input/output interface 318 may serve as means for interfacing with a device—such as a touchscreen—that combines input and output functions. Although FIG. 3 illustrates the input/output device 320 separately from the user terminal 210, the invention is not limited thereto, and the user terminal 210 and the input/output device 320 may be configured as a single device. The input/output interface 338 of the information processing system 230 may likewise serve as means for interfacing with an input or output device (not illustrated) that is connected to, or included in, the information processing system 230. Although FIG. 3 illustrates the input/output interfaces 318 and 338 as components separate from the processors 314 and 334, the invention is not limited thereto, and the input/output interfaces may be included in the processors.

The user terminal 210 and the information processing system 230 may include more components than those illustrated in FIG. 3. However, it is unnecessary to explicitly illustrate most conventional technical components. In one example, the user terminal 210 may include at least some of the input/output devices 320 described above. The user terminal 210 may further include other components such as a transceiver, a GPS module, a camera, various sensors, or a database. For example, if the user terminal 210 is a smartphone, the user terminal 210 may additionally include components typically included in smartphones, such as an accelerometer, a gyroscope, a microphone module, a camera module, various physical buttons, touch panel buttons, input/output ports, or a vibrator for vibration output.

According to one example, the processor 314 of the user terminal 210 may be configured to operate an application or web browser application that provides a service that outputs information associated with a plurality of option products for a specific underlying asset or information associated with expected profit of a selected option product among a plurality of option products. In that case, program code associated with the application may be loaded into the memory 312 of the user terminal 210. While the application is operating, the processor 314 of the user terminal 210 can receive information or data supplied from the input/output device 320 via the input/output interface 318, or can receive information or data from the information processing system 230 via the communication interface 316, and can process and store the received information or data in the memory 312. Additionally, such information or data can be provided to the information processing system 230 via the communication interface 316.

While the application is operating, the processor 314 may receive, via input devices connected to the input/output interface 318—such as a touchscreen, keyboard, camera including an audio sensor or image sensor, or microphone—voice data, text, images, or video that may be input or selected, and may store the received voice data, text, images, or video in the memory 312 or provide them to the information processing system 230 via the communication interface 316 and the network 220. In one example, the processor 314 may receive a user input selecting a graphic object displayed on the display via the input device, and may provide data or a request corresponding to the received user input to the information processing system 230 via the communication interface 316 and the network 220. For example, the processor 314 may provide information identifying a specific underlying asset for which the user wishes to receive option product information, may receive a user input selecting the specific underlying asset, and may request, from the information processing system 230, information associated with a plurality of option products for the specific underlying asset. The information processing system 230 may transmit the information associated with the plurality of option products for the specific underlying asset to the user terminal 210, and the user terminal 210 may output, through the user interface, the information associated with the plurality of option products for the specific underlying asset.

Additionally and/or alternatively, the processor 314 may receive a user input selecting at least one option product among the plurality of option products and may request, from the information processing system 230, information associated with expected profit of the selected option product. The information processing system 230 may transmit, to the user terminal 210, the information associated with expected profit of the selected option product, and the user terminal 210 may output, through the user interface, the information associated with expected profit of the selected option product. Alternatively, the processor 314 may receive a user input selecting at least one option product among the plurality of option products, may calculate information associated with expected profit of the selected option product, and may output, through the user interface, the calculated information associated with expected profit.

The processor 314 of the user terminal 210 may transmit information or data to the input/output device 320 via the input/output interface 318 so as to output them. For example, the processor 314 of the user terminal 210 may output processed information or data via an output device capable of display output (such as a touchscreen or display) or an output device capable of voice output (such as a speaker).

The processor 334 of the information processing system 230 may be configured to manage, process, or store information or data received from the plurality of user terminals 210 or a plurality of external systems. Information or data processed by the processor 334 may be provided to the user terminal 210 via the communication interface 336 and the network 220. For example, the processor 334 may receive, from the user terminal 210, an input associated with selection of a specific underlying asset for which the user wishes to view option products, may generate information associated with a plurality of option products for the selected security, and may provide the generated information to the user terminal 210 via the communication interface 336 and the network 220. Additionally, the processor 334 may receive, from the user terminal 210, an input associated with selection of an option product, may generate information associated with expected profit of the selected option product, and may provide the generated information to the user terminal 210 via the communication interface 336 and the network 220.

FIG. 4 illustrates an example in which a first chart 410 including information associated with a plurality of data elements (e.g., option products) is output. The processor may output the first chart 410 as part of the user interface (for example, the user-interface 100 of FIG. 1). For instance, FIG. 4 illustrates an example where the first chart 410 is output in the first area of the user interface (e.g., the 110 of FIG. 1).

Referring to first example 400a, a plurality of option products for a specific underlying asset may be output in the form of a chart plotted against a plurality of expiration dates and a plurality of strike prices. Here, a first axis 412 of the first chart 410 represents time information associated with expiration dates of the plurality of option products, and a second axis 414 of the first chart 410 may represent strike price information of the specific underlying asset associated with the plurality of option products. For example, the first axis 412 of the first chart 410 may list expiration dates of the plurality of option products in chronological order. Additionally, the second axis 414 of the first chart 410 may list strike prices of the specific underlying asset for the plurality of option products in ascending or descending order.

Each of the plurality of option products may be visualized in the form of an option block and may be mapped to a corresponding position on the first chart. For example, the processor may generate a plurality of option blocks corresponding respectively to the plurality of option products and may map each generated option block to the first chart. Each option block may be mapped to a position that corresponds, on the first axis 412, to expiration date information of the corresponding option product and, on the second axis 414, to strike price information of the corresponding option product. For example, first group option products 420 among the plurality of option products whose expiration date is the same first expiration date may form one first column on the first chart. That is, the processor may map first group option blocks corresponding to the first group option products 420 to the first column on the first chart. As another example, second group option products 430 among the plurality of option products whose strike price is the same first strike price may form one first row on the first chart. That is, the processor may map second group option blocks corresponding to the second group option products 430 to the first row on the first chart. In one example, the plurality of option products may be short-term option products whose expiration dates arrive within less than one year, but the invention is not limited thereto.

The first chart 410 may include quotation information for each of the plurality of option products. Quotation information corresponding to each option product may be displayed in the plurality of option blocks.

The first chart 410 may include trading volume information for each of the plurality of option products. Trading volume information corresponding to each option product may be visually displayed in the plurality of option blocks. For example, trading volume information for each option product may be visually displayed in the plurality of option blocks after being classified according to predetermined numeric ranges.

In one example, trading volume information for each option product may be differentially displayed through color, brightness, saturation, or shape of the respective option block. For example, higher trading volume may be represented by a darker color of the option block, and lower trading volume may be represented by a lighter color of the option block. Accordingly, the user may intuitively compare trading volume information for each of the plurality of option products.

Referring to second example 400b and third example 400c, the user may change, via a predetermined manner input (for example, a scroll input, an axis touch input, or a predetermined shortcut key input), position, type, and/or quantity of the plurality of option products displayed on the user interface. The processor may adjust the depth for each axis direction of the first chart 410 in response to receiving the predetermined-manner input for each axis direction. Here, the depth may denote a range or interval of data that can be displayed along each axis direction of the first chart 410. Accordingly, in response to receiving the predetermined manner input for at least one of the first axis direction or the second axis direction on the first chart 410, the processor may change position, type, and/or quantity of option blocks mapped on the first chart 410.

For example, in response to receiving the predetermined manner input for the first axis direction on the first chart 410, the processor may adjust a range of expiration dates displayed on the first axis 412. For instance, referring to first example 400a and second example 400b, in response to receiving the predetermined manner input, the range of expiration dates displayed on the first axis 412 may be adjusted from a first range of 7 June to 19 July to a second range of 21 June to 3 August. In that case, the processor may change positions of option blocks mapped on the first chart 410 so that respective option blocks whose expiration dates correspond to the adjusted range may be mapped. Additionally and/or alternatively, in response to receiving the predetermined manner input for the first axis direction on the first chart 410, the processor may adjust an interval of expiration dates displayed on the first axis 412. For instance, referring to first example 400a, the interval of expiration dates displayed on the first axis 412 may initially be seven days, but, in response to receiving the predetermined manner input, the interval may be adjusted to fourteen days, twenty-one days, or another value. In that case, the processor may change position or type of option blocks mapped on the first chart 410 so that respective option blocks whose expiration dates correspond to the adjusted interval may be mapped.

As another example, in response to receiving the predetermined manner input for the second axis direction on the first chart 410, the processor may adjust a range of strike prices displayed on the second axis 414. For instance, referring to first example 400a and third example 400c, in response to receiving the predetermined manner input, the range of strike prices displayed on the second axis 414 may be adjusted from a third range of $116 to $126 to a fourth range of $112 to $130. In that case, the processor may change positions of option blocks mapped on the first chart 410 so that respective option blocks whose strike prices correspond to the adjusted range may be mapped. Additionally or alternatively, in response to receiving the predetermined manner input for the second axis direction on the first chart 410, the processor may adjust an interval of strike prices displayed on the second axis 414. For instance, referring to first example 400a, the interval of strike prices displayed on the second axis 414 may initially be $1, but, in response to receiving the predetermined manner input, the interval may be adjusted to $0.5, $2, or another value. In that case, the processor may change position or type of option blocks mapped on the first chart 410 so that respective option blocks whose strike prices correspond to the adjusted interval may be mapped. In one example, the range or interval of strike prices displayed on the second axis 414 may be adjusted based on the current price 416 of the specific underlying asset. For instance, referring to third example 400c, even if the range or interval of strike prices displayed on the second axis 414 is adjusted, the value displayed at the center of the second axis 414 may be fixed to the current price 416 of the specific underlying asset. That is, the range or interval of strike prices displayed on the second axis 414 may be adjusted independently within a price range higher than the current price 416 and a price range lower than the current price 416.

For example, strike prices displayed on the second axis 414 may initially be set as strike prices within a predetermined difference range from the current price 416 of the specific underlying asset. Thereafter, when the predetermined manner input for the second axis direction on the first chart 410 is received, the range or interval of strike prices displayed on the second axis 414 may be adjusted.

By virtue of this configuration, because a plurality of option products may be provided in the form of a chart plotted against a plurality of expiration dates and a plurality of strike prices, the user may view, at a glance, the plurality of option products corresponding to the plurality of expiration dates and a plurality of strike prices. The user can thus easily ascertain, without switching or leaving the screen, the expiration date or strike price for each of the plurality of option products and can change, simply by manipulating the first chart 410, a range and/or interval of expiration dates or strike prices of option products to be viewed.

FIG. 5 illustrates an example in which a second chart 520 containing value fluctuation information (e.g., price fluctuation information) for a specific category (e.g., underlying asset) is output. The processor may output the second chart 520 as at least part of user interfaces 500a or 500b. For example, FIG. 5 illustrates an example in which the second chart 520 is output in a first region (for example, region 110 of FIG. 1) of the user interface.

In one example, the second chart 520 may include price fluctuation information for the specific underlying asset. Referring to user interfaces 500a and 500b, the second chart 520 may be output at a position adjacent to the first chart 510.

In one example, the second chart 520 may be output at a position horizontally adjacent to the first chart 510. Alternatively, the second chart 520 and the first chart 510 may be output in a state in which parts thereof overlap. For instance, part of a graph displayed in the second chart 520 may be output on the first chart 510. The first chart 510 and the second chart 520 may be configured to share a common vertical axis (for example, axis 414 of FIG. 4). Additionally, the horizontal axis (for example, axis 412 of FIG. 4) of the first chart 510 and the horizontal axis of the second chart 520 may be connected on the same line so as to represent a continuous flow of time. Specifically, the first chart 510 may include information on a plurality of option products whose expiration dates arrive in the future relative to the current time, and the second chart 520 may include price fluctuation information for the specific underlying asset relative to the current time. Accordingly, the first chart 510 and the second chart 520 may be connected so as to represent a continuous flow of time relative to the current time.

By virtue of this configuration, because the first chart 510 and the second chart 520 may be connected so as to represent a continuous flow of time, the user may easily understand the relationship between the price of the specific underlying asset and strike prices of the option products.

For example, a processor (for example, processor 314 or 334 of FIG. 3) may receive a predetermined-manner user input (for example, a scroll input, an axis-touch input, or a predetermined shortcut-key input) for switching the screen and may switch the first chart 510 displayed on the user interface 500a or 500b to the second chart 520. Accordingly, the user may alternately confirm the first chart 510 and the second chart 520 without leaving the screen, allowing the user to readily compare price-fluctuation information of the specific security with information associated with the multiple option products.

FIG. 6 illustrates an example in which information associated with expected value (e.g., expected profit) of an data element (e.g., option product) is output. The processor may output, as part of user interfaces 600a and 600b, information associated with expected profit of an option product selected by the user.

In one example, the user may confirm, via a first chart output in a first region 610 of a first user interface 600a, information associated with a plurality of option products for a specific underlying asset and may select at least one option product to be purchased among the plurality of option products. In response to receiving the user input selecting the at least one option product, the processor may output, in a second region 620 of the first user interface 600a, information associated with expected profit of the selected at least one option product. For example, if the user selects the first option product 612, the processor may output, through a cart tab in the second region 620, information associated with expected profit of the first option product 612.

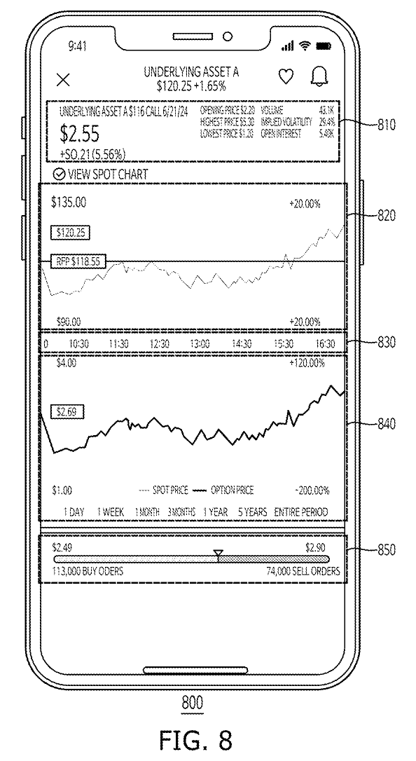

In one example, product information 630 for the selected first option product 612 may be displayed in the second region 620. The product information 630 may include, for example, an underlying security name, option product type (for example, call option or put option), quotation information, strike price information, and expiration date information associated with the option product. The processor may receive a user input selecting the product information 630 via a touch input or the like and may output, as part of user interfaces 600a and 600b, detailed information on the first option product 612. An example in which detailed information on the first option product 612 is provided is described in detail with reference to FIG. 8.

In one example, the user may arbitrarily set an expected price, hereinafter referred to as an “expected price,” of the specific underlying asset on the expiration date of the first option product 612. For example, the expected price set by the user may be output in a first sub-region 622a of the second region 620. Additionally, the first sub-region 622a may output relative ratio information between the expected price and the current price of the specific underlying asset (for example, 0.00 % higher than the current price). Before the user separately sets the expected price, the expected price may initially be set to be identical to the current price of the specific underlying asset, but the invention is not limited thereto.

For example, the user may confirm expected profit of the first option product 612 based on the set expected price. The processor may calculate expected profit of the first option product 612 based on the strike price of the first option product 612, the expected price, quotation information of the first option product 612, transaction fees of the first option product 612, or the like. The processor may output, as part of user interfaces 600a and 600b, the calculated expected profit of the first option product 612. Specifically, expected profit of the first option product 612 may be output in a second sub-region 628a of the second region 620. The second sub-region 628a may output an expected profit ratio according to the calculated expected profit.

In one example, the second region 620 may output a third chart 624a that includes information on the relationship between the strike price of the first option product 612 and the expected price. Here, the third chart 624a may be in the form of a gauge bar. Through the third chart 624a the user may ascertain the magnitude relationship between the strike price (for example, call $116) of the first option product 612 and the expected price (for example, $120.25).

Additionally, the third chart 624a may include information on a profit zone of the first option product 612. For example, the third chart 624a may include a marker (for example, $118.69) indicating an actual profit zone of the first option product 612 that considers quotation of the selected first option product 612 and/or transaction fees.

Referring to a second user interface 600b, the user may adjust the expected price by moving a handle 626b of a third chart 624b. Accordingly, the expected price (for example, $122.00) and relative ratio information between the expected price and the current price of the specific underlying asset (for example, 2.70 % higher than the current price) output in the first sub-region 622b of the second region 620 may be updated. In response to receiving the user input adjusting the expected price, the processor may recalculate the expected profit. In the second sub-region 628b of the second region 620 recalculated expected profit and/or an expected profit ratio may be output.

By virtue of this configuration, by receiving the user input adjusting the expected price of the specific underlying asset on the expiration date and by calculating and providing the corresponding expected profit, the processor can assist the user in formulating an option purchase strategy.

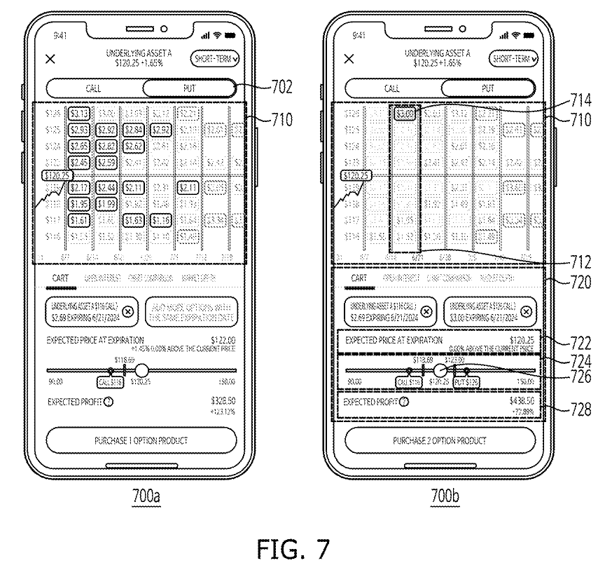

FIG. 7 illustrates an example in which information associated with expected value (e.g., expected profit) of a plurality of data elements (e.g., option products) is output. The processor may output, as part of user interfaces 700a and 700b, information associated with expected profit of a plurality of option products selected by the user. The user may select a plurality of option products related to a specific underlying asset and may confirm information associated with expected profit of the selected a plurality of option products.

Through a tab region 702 of a first user interface 700a the user may set the type of option products to be viewed. The user may select, via a touch input or the like, a tab (for example, a call-tab or a put-tab) in the tab region 702 to receive information associated with call option products or put option products. For example, if the user selects the call tab in the tab region 702, the processor may output, in a first region 710 of the first user interface 700a, information associated with a plurality of call option products for a specific underlying asset in the form of a chart. Additionally, if the user selects the put tab in the tab region 702, the processor may output, in the first region 710 of the first user interface 700a, information associated with a plurality of put option products for the specific underlying asset in the form of a chart.

Through the first region 710 the user may select a plurality of option products among a plurality of call option products or a plurality of put option products in order to purchase the option products (or to establish a synthetic position strategy). For example, the user may select a first option product among a plurality of call option products and may select a second option product among a plurality of put option products. As another example, the user may select both a first option product and a second option product among a plurality of call option products. Yet another example, the user may select both a first option product and a second option product among a plurality of put option products. Additional option products besides the first and second option products may of course be selected.

Referring to a second user interface 700b, expiration dates of the selected a plurality of option products may all be identical. For example, when the processor receives a user input selecting a first option product among a plurality of option products for a specific underlying asset, the processor may activate selection of at least some option products among the plurality of option products for the specific underlying asset whose expiration date is identical to that of the first option product. Specifically, if the user selects a first option product having a specific expiration date (for example, 21 June), only at least some option products 712 having the same expiration date as the first option product may be activated so as to be selectable. The user may select a second option product 714 among the at least some option products 712 that the user wishes to purchase.

For example, a third chart 724, which includes information about the relationship between the exercise price of the selected first option product, the exercise price of the selected second option product 714, and the expected price of a specific security on the expiration date common to both the first and second option products 714, may be output in a second region 720 of the second user interface 700b. Here, the third chart 724 may be in the form of a gauge bar. Through the third chart 724, the user may ascertain the magnitude relationship among the exercise prices of the first option product (e.g., call $116), the second option product 714 (e.g., put $126), and the expected price (e.g., $120.25).

In one example, the user may confirm an expected profit of the first option product and the second option product 714 based on the expected price. The processor may calculate expected profit of the first option product and the second option product 714 based on the expected price set by the user. Additionally and/or alternatively, the processor may output, as at least part of user interfaces 700a and 700b, the calculated expected profit of the first option product and the second option product 714. Specifically, expected profit of the first option product and the second option product 714 may be output in a second sub-region 728 of the second region 720. The second sub-region 728 may output an expected profit ratio according to the calculated expected profit.

For example, the third chart 724 may include information on profit zones of the first option product and the second option product 714. For example, the third chart 724 may include markers (for example, $118.69 and $123.00) that indicate actual profit zones of the first option product and the second option product 714 that consider quotations, transaction fees, or the like.

The user may adjust the expected price by moving a handle 726 of the third chart 724. Accordingly, the expected price and relative ratio information between the expected price and the current price of the specific underlying asset output in a first sub-region 722 of the second region 720 may be updated. In response to receiving the user input adjusting the expected price, the processor may recalculate the expected profit. Additionally, the processor may output recalculated expected profit and/or an expected profit ratio in the second sub-region 728 of the second region 720.

By virtue of this configuration, the user may combine at least some of a plurality of call option products and/or a plurality of put option products for a specific underlying asset to create the user’s own synthetic position. Furthermore, by receiving information on expected profit associated with the created synthetic position, the user may establish a rational purchase strategy for option products.

FIG. 8 illustrates an example in which detailed information on a selected data element (e.g., option product) among a plurality of data elements (e.g., option products) is output. In response to receiving the user input selecting the product information (for example, item 630 of FIG. 6), the processor may output, as at least part of a user interface 800, detailed information on the option product.

For example, a first region 810 of the user interface 800 may output product information on the option product selected by the user. For example, the first region 810 may output, for example, an underlying security name, option product type (for example, call option or put option), quotation information, strike price information, expiration date information, and trading volume information associated with the option product.

A second region 820 of the user interface 800 may output a second chart. The second chart may include price fluctuation information for the specific underlying asset associated with the option product selected by the user. For example, the second chart may include information on price fluctuations of the specific underlying asset along a time axis 830. Additionally, a third region 840 of the user interface 800 may output a fourth chart. The fourth chart may include price fluctuation information for the option product selected by the user. For example, the fourth chart may include information on price fluctuations of the option product along the time axis 830.

For example, the second chart and the fourth chart may be output at positions adjacent to each other on the user interface 800. In FIG. 8 the second region 820 that outputs the second chart is depicted as being located in an upper part of the user interface 800, and the third region 840 that outputs the fourth chart is depicted as being located in a lower part of the second region 820, but positions and/or relative positions of the second region 820 and the third region 840 may be changed according to user interface design.

For example, via a predetermined manner input (for example, a scroll input or an axis touch input) the user may adjust a range, type, and/or quantity of data displayed in the second region 820 and/or the third region 840. Specifically, the user may adjust a depth of data output in the second chart and the fourth chart by a touch input on the second chart or the fourth chart, or by a scroll input along the time axis 830 direction.

In one example, the second chart and the fourth chart may be configured to share the same time axis 830. Accordingly, data output in the second chart and the fourth chart may be interlinked. Additionally, the processor may synchronize the second chart and the fourth chart based on the same time axis 830. In other words, the second chart and the fourth chart may be interlinked so as to represent data for the same time periods. Accordingly, even if the user adjusts only a depth of the time axis 830 of either the second chart or the fourth chart, data output in the second chart and the fourth chart may be interlinked and adjusted in real time.

For example, a fourth region 850 of the user interface 800 may output a chart that includes information on quantities of a plurality of option products with registered buy and sell orders and information on current prices of the option products.

By virtue of this configuration, because the second chart and the fourth chart may be output at positions adjacent to each other and may be synchronized based on the same time axis 830, the user may readily identify price fluctuation trends for the specific underlying asset and option products associated with the specific underlying asset over the same time period.

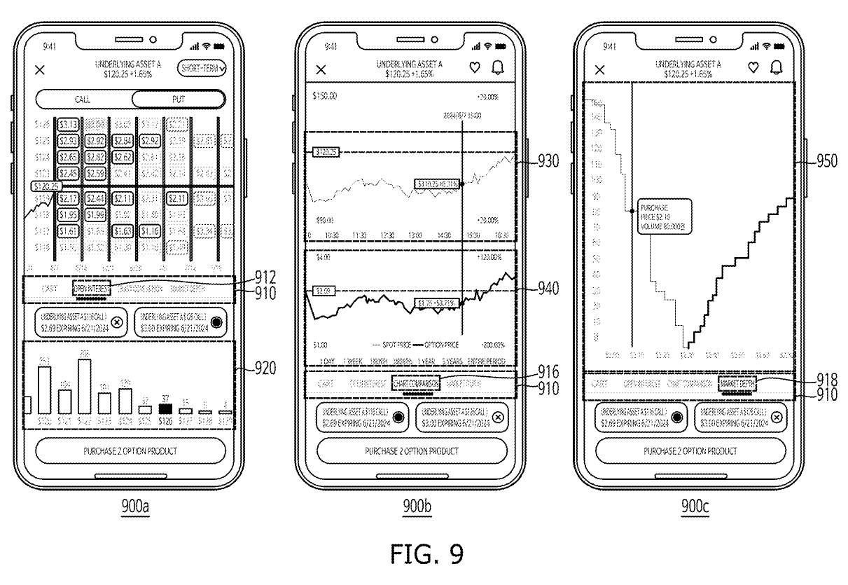

FIG. 9 illustrates an example in which various information associated with a plurality of data elements (e.g., option products) is output. Information associated with a plurality of option products for a specific underlying asset may include at least one of information on open interest among the plurality of option products, information for comparing a price fluctuation chart of the specific underlying asset with a price fluctuation chart of the option product, or information on market depth of the option product.

Referring to a first user interface 900a, by selecting an open interest tab 912 in a tab region 910 the user may receive information on open interest among the plurality of option products. For example, the processor may output, in a first region 920 of the first user interface 900a, information on open interest among the plurality of option products.

Referring to a second user interface 900b, by selecting a chart comparison tab 916 in the tab region 910 the user may receive information for comparing a price fluctuation chart of the specific underlying asset with a price fluctuation chart of the option product. For example, the processor may output, in a second region 930 of the second user interface 900b, a second chart that represents price fluctuation information of the specific underlying asset, and may output, in a third region 940 of the second user interface 900b, a fourth chart that represents price fluctuation information of the option product. The second chart and the fourth chart may be output at positions adjacent to each other and, by being synchronized so as to share the same time axis, may represent data for the same time periods.

Referring to a third user interface 900c, by selecting a market depth tab 918 in the tab region 910 the user may receive information on market depth of the specific underlying asset. Here, the information on market depth may include information on distribution of sell orders or buy orders for option products that are tradable in real time in the market. The processor may output, in a fourth region 950 of the third user interface 900c, information on market depth of the option products.

By virtue of this configuration, before creating an order for an option product that the user wishes to purchase, the user may readily receive various information related to the option product and the specific underlying asset associated with the option product.

Sizes and/or positions of the first to the fourth regions 920, 930, 940, and 950 output in the user interfaces 900a, 900b, and 900c of FIG. 9 may be merely examples and may vary according to user interface design.

FIG. 10 illustrates an example in which information associated with an interaction for a data element is output. Specifically, FIG. 10 illustrates an example in which information associated with an order for an option product is output. For example, FIG. 10 illustrates a user interface provided by selecting a buy button associated with an order for an option product selected by the user.

A first user interface 1000a may output information associated with an order for at least one option product that the user wishes to purchase. For example, information associated with an order for a first option product that the user wishes to purchase may be output in a first region 1010, and information associated with an order for a second option product that the user wishes to purchase may be output in a second region 1020. In FIG. 10, the first region 1010 is depicted as being located in an upper part of the first user interface 1000a and the second region 1020 is depicted as being located in a lower part of the first region 1010, but sizes and/or positions of the first region 1010 and the second region 1020 may vary according to user interface design.

In one example, the first region 1010 may include price information for the first option product that the user wishes to purchase. The user may adjust the purchase price of the first option product by selecting a price selection box 1012 of the first region 1010 via a touch input or the like.

In one example, the first region 1010 may include quantity information for the first option product that the user wishes to purchase. The user may adjust a purchase quantity of the first option product by selecting a quantity selection box 1014 of the first region 1010 via a touch input or the like.

In one example, the first region 1010 may include a quotation view button 1016 for confirming quotation information for the first option product that the user wishes to purchase. In response to receiving the user input selecting the quotation view button 1016, the processor may output, as at least part of a second user interface 1000b, a chart that includes quotation information for the first option product. The chart output through the second user interface 1000b may include information on remaining sell orders or remaining buy orders for the first option product by quotation.

A third region 1030 of the first user interface 1000a may output information on a final amount for option products that the user ultimately wishes to purchase. Additionally, a fourth region 1040 of the first user interface 1000a may output information on total expected profit associated with the option products that the user ultimately wishes to purchase. When the user changes at least one of price or quantity of an option product to be purchased via at least one of the price selection box 1012 or the quantity selection box 1014 of the first region 1010, information on a final amount for the option products output in the third region 1030 and information on total expected profit associated with the option products output in the fourth region 1040 may be updated.

By virtue of this configuration, before registering a buy and sell order for an option product, the user may confirm quantity and/or price information for the option product to be traded and may receive information on total expected profit corresponding thereto, thereby obtaining assistance in making a final decision on trading the option product.

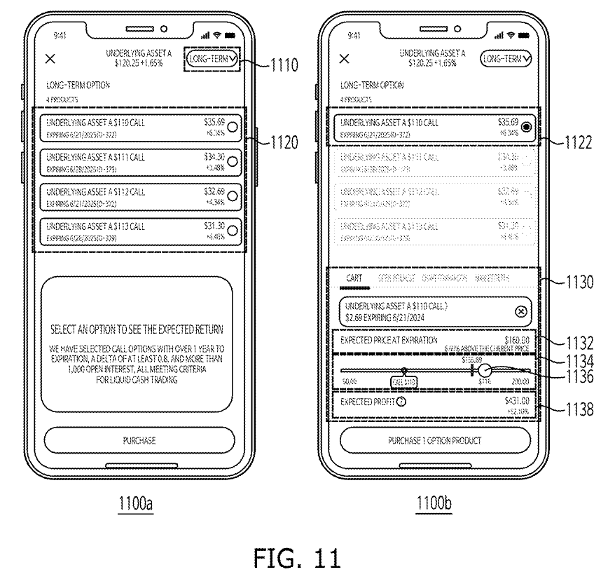

FIG. 11 illustrates an example in which information associated with long-term data elements (e.g., long-term option products) is output. The processor may output, as at least part of user interfaces 1100a and 1100b, information associated with long-term option products.

In one example, by selecting a period tab 1110 of a first user interface 1100a the user may select a type of option products according to characteristics of the option products to be purchased (for example, short-term option products or long-term option products). In response to receiving a user input selecting long-term option products, the processor may output, in a first region 1120 of the first user interface 1100a, information associated with the long-term option products. Here, long-term option products may denote option products whose expiration dates arrive after a period of one year or more.

Through the first region 1120 of the first user interface 1100a the user may view a plurality of long-term option products for the specific underlying asset. For example, a plurality of long-term option products plotted against a plurality of expiration dates and a plurality of strike prices may be output in the form of a list in the first region 1120.

Through a second user interface 1100b the user may select at least one long-term option product among the plurality of long-term option products. For example, the user may select a first long-term option product 1122 among the plurality of long-term option products output in the form of a list. In response to receiving the user input selecting the first long-term option product 1122, the processor may output, in a second region 1130 of the second user interface 1100b, information associated with expected profit of the first long-term option product 1122.

In one example, a third chart 1134 that includes information on the relationship between the strike price of the selected first long-term option product 1122 and an expected price of the specific underlying asset on the expiration date of the first long-term option product 1122 may be output in the second region 1130 of the second user interface 1100b. Through the third chart 1134 the user may ascertain the magnitude relationship between the strike price (for example, call $110) of the first long-term option product 1122 and the expected price (for example, $116). Additionally, through the third chart 1134 the user may confirm information on a profit zone of the first long-term option product 1122.

For example, the user may confirm expected profit of the first long-term option product 1122 based on the expected price. The processor may calculate expected profit of the first long-term option product 1122 based on the expected price set by the user. Additionally, the processor may output, as part of the user interface 1100b, the calculated expected profit of the first long-term option product 1122. Specifically, expected profit of the first long-term option product 1122 may be output in a second sub-region 1138 of the second region 1130. The second sub-region 1138 may output an expected profit ratio according to the calculated expected profit.

The user may adjust the expected price by moving a handle 1136 of the third chart 1134. Accordingly, the expected price and relative ratio information between the expected price and the current price of the specific underlying asset output in a first sub-region 1132 of the second region 1130 may be updated. In response to receiving the user input adjusting the expected price, the processor may recalculate the expected profit. Accordingly, recalculated expected profit and/or an expected profit ratio may be output in the second sub-region 1138 of the second region 1130.

By virtue of this configuration, the processor can adopt an optimal presentation form for providing information related to option products depending on characteristics of the option products. For example, if the option products may be long-term option products, the kinds and/or quantities of option products that should be output in a quotation window may be fewer, or intervals between respective expiration dates may be longer, than in the case of short-term option products. In that case, by outputting a plurality of long-term option products in the form of a list instead of a chart, the processor may allow the user to comprehend information on option products more effectively.

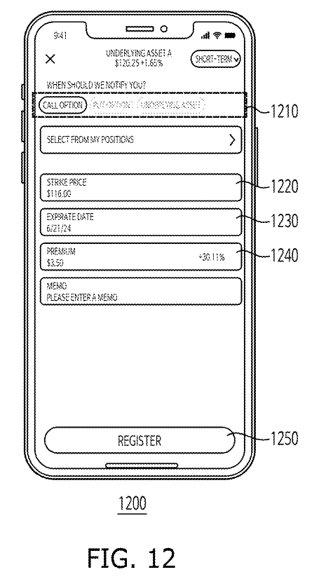

FIG. 12 illustrates an example of setting a registration alert for a data element (e.g., option product). In one example, the user may input trading conditions for an option product to be traded and may set the receipt of an alert when a buy and sell order for an option product satisfying the trading conditions is registered.

Through a first region 1210 of a user interface 1200, the user may set a type of option product to be purchased (for example, call option product or put option product). Additionally and/or alternatively, the user may set receipt of a registration alert for a buy and sell order for a specific underlying asset.

Through the user interface 1200, the user may set the strike price information 1220, expiration date information 1230, and quotation information 1240 for the option product to be traded. Additionally and/or alternatively, by selecting a register button 1250 of the user interface 1200, the user may set to receive a registration alert for a buy-and-sell order for an option product satisfying the set trading conditions.

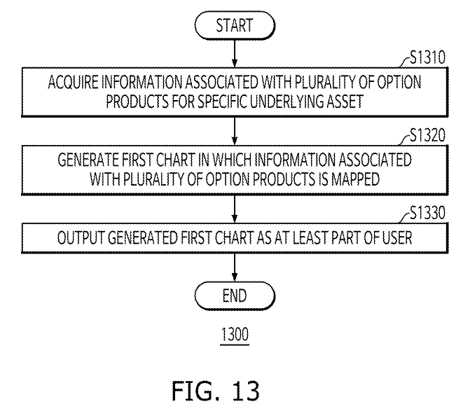

FIG. 13 is a flowchart illustrating a method for supporting display and actions related to data elements. Specifically, FIG. 13 is a flowchart illustrating a method for trading of option products. The method 1300 may be performed by at least one processor. For example, the method 1300 may be performed by at least one processor (hereinafter referred to simply as a “processor”) of a user terminal or at least one processor of an information processing system.

The method 1300 may begin with the processor acquiring information associated with a plurality of option products for a specific underlying asset (S1310). The information associated with the plurality of option products may include expiration date information for each option product and strike price information for the specific underlying asset on the expiration date of each option product. Additionally, the information associated with the plurality of option products may further include at least one of trading volume information or quotation information for each option product.

The processor may generate a first chart in which the information associated with the plurality of option products is mapped (S1320). In that case, a first axis of the first chart represents time information associated with expiration dates of the plurality of option products, and a second axis of the first chart may represent strike price information of the specific underlying asset associated with the plurality of option products.

In one example, to generate the first chart the processor may generate a plurality of option blocks corresponding respectively to the plurality of option products and may map each generated option block to the first chart. In that case, each option block may be mapped to a position corresponding, on the first axis, to expiration date information of the respective option product and, on the second axis, to strike price information of the respective option product.

In one example, the processor may generate a plurality of option blocks in which trading volume information for each option product is displayed. Trading volume information for each option product may be visually displayed in the plurality of option blocks so as to be classified according to predetermined numeric ranges. Additionally and/or alternatively, the processor may generate a plurality of option blocks in which quotation information for each option product is displayed.

The processor may output the generated first chart as at least part of a user interface (S1330). In one example, the processor may receive a predetermined manner input with respect to at least one of a first axis direction or a second axis direction on the first chart. Additionally, in response to receiving the predetermined manner input, the processor may change a position or type of option blocks mapped on the first chart.

Specifically, in response to receiving the predetermined manner input with respect to the first axis direction of the first chart, the processor may adjust a range or interval of expiration dates displayed on the first axis. Additionally, the processor may change a position or type of option blocks mapped on the first chart so that respective option blocks whose expiration dates correspond to the adjusted range or interval may be mapped.

As another example, in response to receiving the predetermined manner input with respect to the second axis direction of the first chart, the processor may adjust a range or interval of strike prices displayed on the second axis. Additionally, the processor may change a position or type of option blocks mapped on the first chart so that respective option blocks whose strike prices correspond to the adjusted range or interval may be mapped on the first chart.

In one example, the processor may output, at a position adjacent to the first chart, a second chart that represents price fluctuation information of the specific underlying asset as at least part of the user interface. In that case, a third axis of the second chart represents time information, and a fourth axis of the second chart may represent price information of the specific underlying asset. Additionally, the first axis of the first chart and the third axis of the second chart may be connected on the same line so as to represent a continuous flow of time.

In response to receiving an input selecting a first option product among the plurality of option products, the processor may output information associated with expected profit of the first option product as at least part of the user interface. Expected profit may be calculated based on the strike price of the first option product and an expected price of the specific underlying asset on the expiration date of the first option product. The processor may output, as at least part of the user interface, a third chart that includes information on the relationship between the strike price of the first option product and the expected price of the specific underlying asset on the expiration date of the first option product. The third chart may include information on a profit zone of the first option product.

In one example, in response to receiving an input that adjusts the expected price through the third chart, the processor may recalculate expected profit of the first option product. Additionally, the processor may output recalculated expected profit information as at least part of the user interface.

Additionally, the processor may further receive an input selecting a second option product whose expiration date is identical to that of the first option product among the plurality of option products. For example, the processor may receive an input selecting the second option product among at least some option products whose selection is activated and whose expiration date is identical to that of the first option product. In that case, the expected profit information may include information associated with expected profit of the first option product and the second option product.

In one example, in response to receiving an input requesting an order for the selected first option product, the processor may output information associated with the order for the first option product as at least part of the user interface. In that case, in response to receiving an input setting quantity information of the first option product, the processor may calculate total expected profit of the first option product based on the set quantity information and may output information on the calculated total expected profit as at least part of the user interface.

The flowchart illustrated in FIG. 13 and the description above may be merely examples, and the method may be implemented differently in some examples. For example, one or more steps illustrated in FIG. 13 may be omitted, orders of the respective steps may be changed, one or more steps may be overlapped, or one or more steps may be repeated a plurality of times.

The above described method may be provided as a computer program stored on a computer-readable recording medium for execution on a computer. The medium may be one that permanently stores a computer-executable program or that temporarily stores the program for execution or download. The medium may be any single or a plurality of recording or storage means formed as combined hardware, and is not limited to a medium directly connected to a computer system but may exist in a distributed manner on a network. Examples of media include magnetic media such as hard discs, floppy discs, and magnetic tapes; optical recording media such as CD-ROMs and DVDs; magneto optical media such as floptical discs; and program instruction stored media including ROM, RAM, or flash memory. Other examples of media may include storage media managed by app stores distributing applications or various sites or servers supplying or distributing other software.

The methods, operations, or techniques of the present disclosure may be implemented in various ways. For example, such techniques may be implemented by hardware, firmware, software, or a combination thereof. Those skilled in the art will understand that various exemplary logical blocks, modules, circuits, and algorithm steps described in connection with the present disclosure may be implemented as electronic hardware, computer software, or combinations of both.

To clearly describe the interchangeability of hardware and software, various exemplary components, blocks, modules, circuits, and steps have been described above in functional terms. Whether such functionality is implemented as hardware or software depends upon particular application specific design constraints imposed on the overall system. Skilled artisans may implement the described functionality in varying ways for each particular application without departing from the scope of the present disclosure.

In a hardware implementation, processing units used to perform the techniques may be implemented within one or more ASICs, DSPs, digital signal processing devices, programmable logic devices, field programmable gate arrays, processors, controllers, microcontrollers, microprocessors, electronic devices, other electronic units designed to perform the functions described herein, computers, or combinations thereof.

Accordingly, various exemplary logical blocks, modules, and circuits described in connection with the present disclosure may be implemented or performed within a general purpose processor, a DSP, an ASIC, an FPGA, or another programmable logic device, discrete gate or transistor logic, discrete hardware components, or any combination thereof designed to perform the functions described herein. A general purpose processor may be a microprocessor, but, in the alternative, the processor may be any conventionally available processor, controller, microcontroller, or state machine. The processor may also be implemented as a combination of computing devices—for example, a combination of a DSP and a microprocessor, a plurality of microprocessors, one or more microprocessors in conjunction with a DSP core, or any other such configuration.

In a firmware or software implementation, the techniques may be implemented with modules (e.g., procedures, functions, etc.) that perform the functions described herein. Any machine-readable medium tangibly embodying program instructions may be used for implementing the techniques described herein. For example, software codes can be stored in a memory and executed by a processor. Memory may be implemented within the processor or external to the processor, in which case it can be communicatively coupled to the processor via various means as is known in the art.

Although the examples described above have been shown and described with respect to at least one standalone computer system, the present disclosure is not limited thereto and may be implemented in any computing environment such as a network or a distributed computing environment. Further, aspects of the subject matter of the present disclosure may be implemented across a plurality of processing chips or devices, and storage may be affected similarly across a plurality of devices. Such devices may include PCs, network servers, and portable devices.

While the present disclosure has been described with reference to some examples, it will be understood by those skilled in the art that various changes in form and details may be made without departing from the scope of the invention as defined by the appended claims.

What is claimed is:

1. A method configured to enable display of voluminous amounts of data on limited display screens, the method comprising:
acquiring information associated with a plurality of option products for a specific underlying asset, the information including, for each option product, information on an expiration date and information on a strike price for the specific underlying asset on the expiration date;
generating a first chart in which the information associated with the plurality of option products is mapped; and
outputting the generated first chart as at least part of a user interface,
wherein a first axis of the first chart represents time information on the expiration dates of the plurality of option products, and a second axis of the first chart represents information on the strike prices of the specific underlying asset associated with the plurality of option products.

2. The method as claimed in claim 1, wherein generating the first chart comprises mapping, to a first column of the first chart, a first group of option products whose expiration dates are a first expiration date among the plurality of option products.

3. The method as claimed in claim 1, wherein generating the first chart comprises mapping, to a first row of the first chart, a second group of option products whose strike prices are a first strike price among the plurality of option products.

4. The method as claimed in claim 1, wherein generating the first chart comprises:
generating a plurality of option blocks corresponding respectively to the plurality of option products; and
mapping the plurality of option blocks to the first chart,
wherein each of the plurality of option blocks is mapped to a position corresponding, on the first axis, to information on the expiration dates of the respective option products and, on the second axis, to information on the strike prices of the respective option product.

5. The method as claimed in claim 4, wherein outputting comprises:
receiving a predetermined manner input with respect to at least one of a direction of the first axis of the first chart or a direction of the second axis of the first chart; and
in response to receiving the predetermined manner input, changing positions or types of option blocks mapped on the first chart.

6. The method as claimed in claim 5, wherein changing comprises:
in response to receiving the predetermined manner input with respect to the first axis direction of the first chart, adjusting a range or interval of the expiration dates displayed on the first axis; and
changing the positions or types of the option blocks so that option blocks whose expiration dates fall within the adjusted range or interval are mapped on the first chart.

7. The method as claimed in claim 5, wherein changing comprises:
in response to receiving the predetermined manner input with respect to the second axis direction of the first chart, adjusting a range or interval of the strike prices displayed on the second axis; and
changing the positions or types of the option blocks so that option blocks whose strike prices fall within the adjusted range or interval are mapped on the first chart.

8. The method as claimed in claim 4, wherein the information associated with the plurality of option products further includes trading volume information for each of the plurality of option products, and
generating the plurality of option blocks includes generating option blocks in which the trading volume information for each of the plurality of option products is displayed.

9. The method as claimed in claim 8, wherein the trading volume information for each of the plurality of option products is visually displayed on the plurality of option blocks to be classified according to predetermined numeric ranges.

10. The method as claimed in claim 4, wherein the information associated with the plurality of option products further includes quotation information for each option product, and generating the plurality of option blocks includes generating option blocks in which the quotation information for each option product is displayed.

11. The method as claimed in claim 1, wherein outputting comprises outputting, at a position adjacent to the first chart, a second chart that represents price fluctuation information of the specific underlying asset as at least part of the user interface,
a third axis of the second chart represents time information and a fourth axis represents price information of the specific underlying asset.

12. The method as claimed in claim 11, wherein the first axis of the first chart and the third axis of the second chart are aligned on a same line so as to represent a continuous flow of time.

13. The method as claimed in claim 1, further comprising, in response to receiving an input selecting a first option product among the plurality of option products, outputting information associated with expected profit of the first option product as at least part of the user interface.

14. The method as claimed in claim 13, wherein the expected profit is calculated based on a strike price of the first option product and an expected price of the specific underlying asset on an expiration date of the first option product, and
outputting the information associated with the expected profit includes outputting, as part of the user interface, a third chart that contains information regarding a relationship between the strike price and the expected price.

15. The method as claimed in claim 14, wherein outputting the information associated with the expected profit further comprises:
in response to receiving an input that adjusts the expected price through the third chart, recalculating the expected profit; and
outputting information on the recalculated expected profit as at least part of the user interface.

16. The method as claimed in claim 14, wherein the third chart includes information on a profit zone of the first option product.

17. The method as claimed in claim 13, wherein outputting the information associated with the expected profit further comprises receiving an input selecting a second option product whose expiration date is identical to an expiration date of the first option product, and the information associated with the expected profit includes information on expected profits for the first option product and the second option product.

18. The method as claimed in claim 17, wherein receiving the input selecting the second option product comprises receiving the input selecting the second option product from among at least some option products whose expiration date is identical to an expiration date of the first option product for which selection is active.

19. A computer-readable recording medium storing a computer program for executing the method according to claim 1 on a computer.

20. A computing device configured to enable display of voluminous amounts of data on limited display screens, the computing device comprising:
a memory; and
at least one processor coupled to the memory and configured to execute at least one computer-readable program stored in the memory,
wherein the at least one program instructs the processor to:
acquire information associated with a plurality of option products for a specific underlying asset, the information including, for each option product, information on an expiration date and information on a strike price for the specific underlying asset on the expiration date;
generate a first chart in which the information associated with the plurality of option products is mapped; and
output the generated first chart as at least part of a user interface,
wherein a first axis of the first chart represents time information on the expiration dates of the plurality of option products, and a second axis of the first chart represents information on the strike prices of the specific underlying asset associated with the plurality of option products.
